(19) United States
(12) Patent Application Publication
(10) Pub. No.: US 2011/0227880 A1
(43) Pub. Date: Sep. 22, 2011

(54) TELESCOPING STYLUS FOR PORTABLE ELECTRONIC DEVICE

(75) Inventors: SHI-XU LIANG, Shenzhen (CN); YUNG-CHANG YEN, Shindian (TW); JUN-LIN CHEN, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/913,937

(22) Filed: Oct. 28, 2010

(30) Foreign Application Priority Data
Mar. 22, 2010 (CN) 201010129503.0

(51) Int. Cl. G06F 3/033

(52) U.S. Cl. 345/179

(57) ABSTRACT

A telescoping stylus includes a housing, a first stopper member, a second member, and a core member. The first stopper member is attached to one end of the housing. The second stopper member is attached to another end of the housing. The core member is slidably received in the housing. The core member selectively engages with the first stopper member or the second member to be positioned in the housing.

### BACKGROUND

1. Technical Field

The present disclosure relates to styluses, and more particularly to a telescoping stylus for portable electronic device (e.g., mobile phone).

2. Description of Related Art

Styluses are used as input devices for writing, marking, or pressing on pressure-sensitive screens.

Styluses are usually stored on or in an electronic device, and so are made small. For many people it is difficult to easily and accurately manipulate small styluses, therefore telescoping styluses have come into use. Some conventional telescoping styluses may be telescoped to various lengths and held in position by friction. However, when the telescoping styluses are used for a period of time, the friction may become less and the telescoping styluses are not so easily maintained at different lengths, and so are also not suitable or comfortable for everyone.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present telescoping stylus for portable electronic device. Moreover, in the drawings, like reference numerals designate corresponding parts throughout the several views.

FIG. 1 is an assembled, isometric view of an exemplary telescoping stylus.

FIG. 2 is an exploded, isometric view of the exemplary telescoping stylus of FIG. 1.

FIG. 3 is similar to FIG. 2, but shown from another aspect.

FIG. 4 is a cross-sectional view of FIG. 1 taken along line IV-IV.

FIG. 5 is a stretched state view of FIG. 1.

FIG. 6 is a cross-sectional view of FIG. 5 taken along line VI-VI.

### DETAILED DESCRIPTION

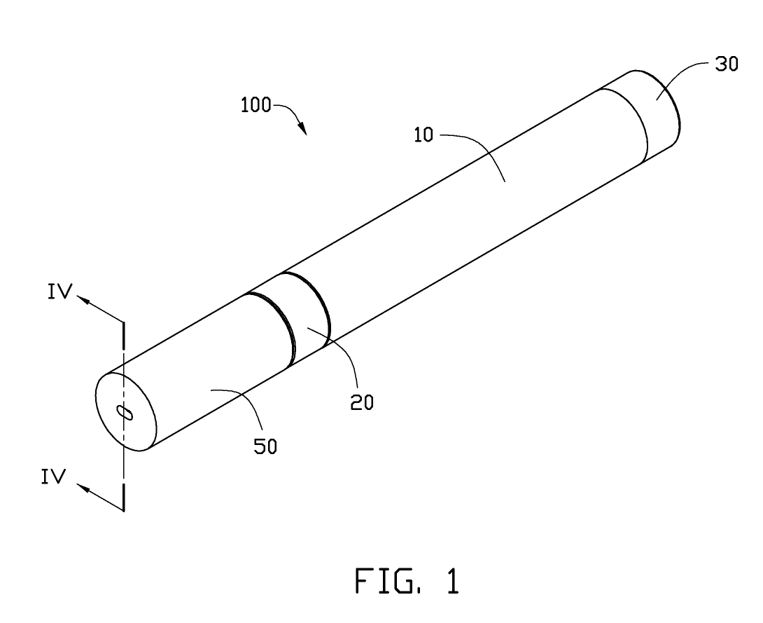

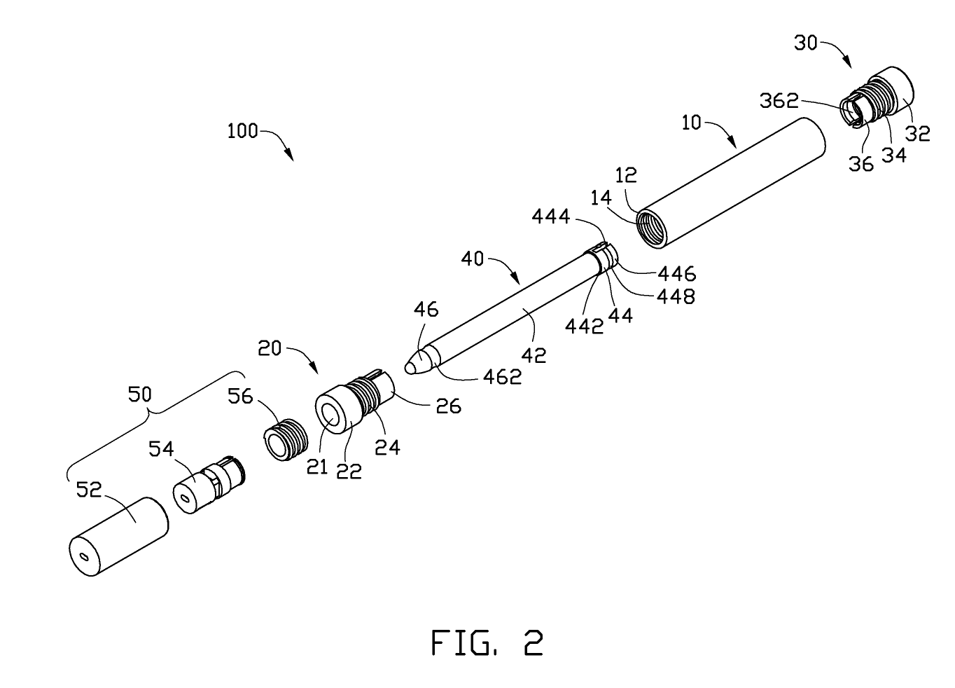

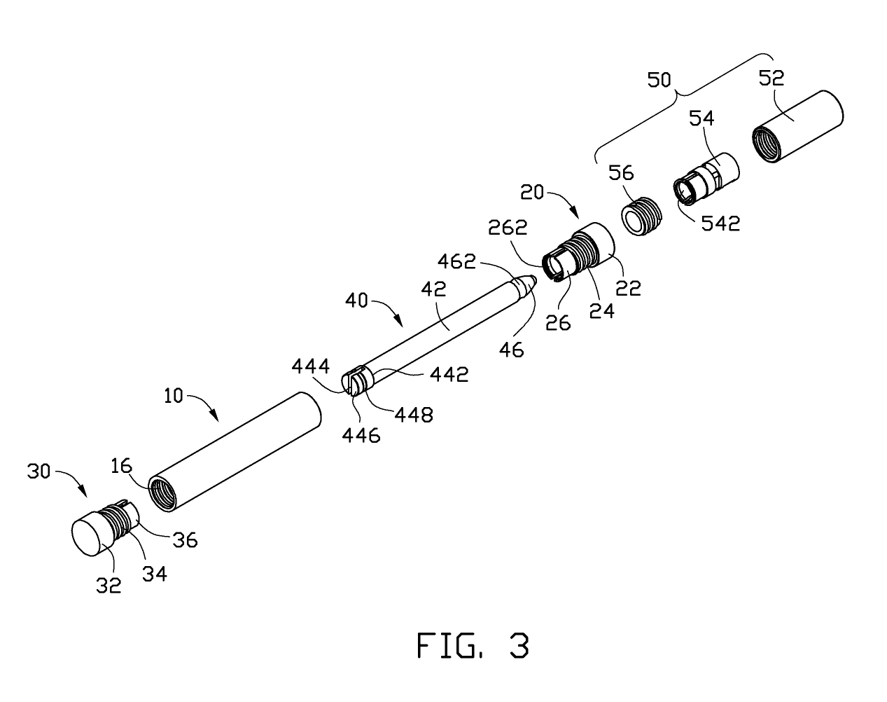

FIGS. 1 to 3 show an exemplary embodiment of a telescoping stylus 100 used with a portable electronic device, such as a mobile phone. The stylus 100 includes a housing 10, a first stopper member 20, a second stopper member 30, a core member 40, and a cap 50. The first stopper member 20 and the second stopper member 30 are respectively positioned at two ends of the housing 10. The core member 40 is slidably received in the housing 10. The core portion 40 includes a nib portion 46. The cap 50 is fitted over the nib portion 46, and abuts against the first stopper member 20.

The housing 10 is substantially a hollow cylinder, and defines a receiving cavity 12 therein. Opposite ends of the housing 10 respectively define a first inner thread 14 and a second inner thread 16 in the receiving cavity 12.

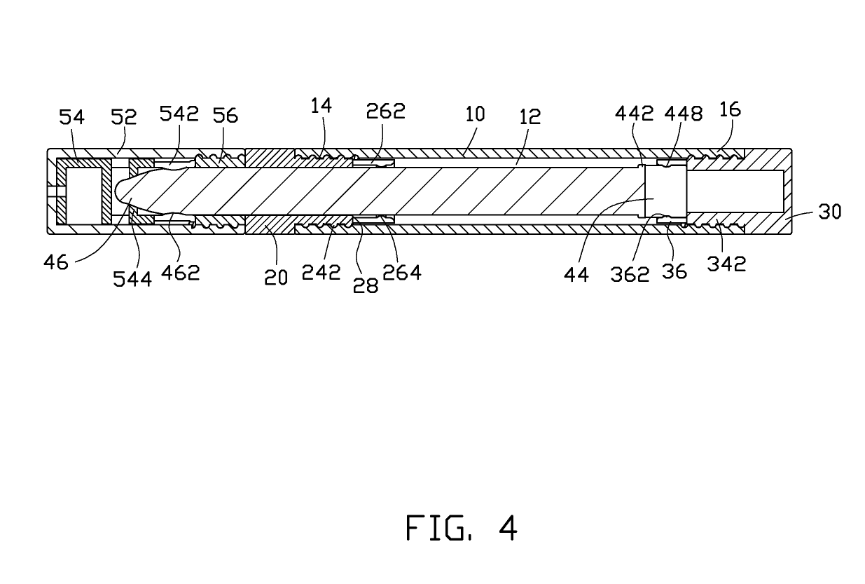

The first stopper member 20 is substantially a hollow sleeve defining a through hole 21 for allowing the core member 40 to extend through. The first stopper member 20 includes a head portion 22, a threaded portion 24, and two opposite arms 26. The head portion 22 has an outside diameter which is large enough to allow it to be abutted against one end of the housing 10. The threaded portion 24 engages with the inner thread 16 of the housing 10 to allow the first stopper member 20 to be fixed in the housing 10. The arms 26 have enough elasticity to stretch under an outer force. Referring to FIG. 4, the arms 26 have a larger inner diameter than the thread portion 24, thereby forming a step 18. An arcuate projection 262 protrudes from an inside of each arm 26.

The structure of the second stopper member 30 is similar to the first member 20. The second stopper member 30 also includes a head portion 32, a threaded portion 34, and two opposite arms 36. The head portion 32 abuts against another end of the housing 10. The threaded portion 24 engages with the inner thread 14 of the housing 10 to allow the second stopper member 30 to be fixed in the housing 10. Referring to FIG. 4, an arcuate projection 362 protrudes from an inside of each arm 36. A step 38 is formed between the threaded portion 34 and the arms 36 in the second stopper member 30.

The core member 40 includes a shank portion 42, a latching portion 44, and the nib portion 46. The latching portion 44 and the nib portion 46 are formed at opposite ends of the core member 40. The latching portion 44 has a larger diameter than the shank portion 42 to form a resisting portion 442 at an intersection therebetween. The latching portion 44 defines a cutout 444 along an axial direction of the core member 40 to form two divisional latching walls 446. Each latching wall 446 defines a latching groove 448. The projections 262, 362 may releasably engage with the latching grooves 448 to allow the core member 40 to be positioned in the housing 10. One end of the nib portion 46 is used for contacting a pressure-sensitive screen. A ring slot 462 is defined in the nib portion 46.

The cap 50 includes a cover <not sure what you meant by this> portion 52, a holding portion 54 and a limiting portion 56. The holding portion 54 can be received in the cover portion 52. A rib 542 extends from an inner peripheral wall of the holding portion 54. The limiting portion 56 is fixed in the cover portion 52 to tightly contact the core member 40.

Referring to FIGS. 1 and 4, when the telescoping stylus 100 is assembled, the first stopper member 20 is fixed at one end of the housing 10 by the threaded portion 24 engaging with the first thread 14. The core member 40 is inserted into the receiving cavity 12 of the housing 10 to allow the nib portion 46 to be exposed from the first stopper member 20. The second stopper member 30 is fixed at another end of the housing 10 by the threaded portion 34 engaging with the second thread 16. The core member 40 is pushed to slide in the receiving cavity 12 to allow the projection 362 to be received in the latching groove 448. The holding portion 54 and the limiting portion 56 are received in the cover portion 52, and the limiting portion 56 is fixed in the cover portion 52 by heat melting. The assembled cap 50 is fitted over the nib portion 46, and the rib 542 is engaged in the ring slot 462 to latch the cap 50 to the core member 40. Thus, assembly of the telescoping stylus 100 is finished.

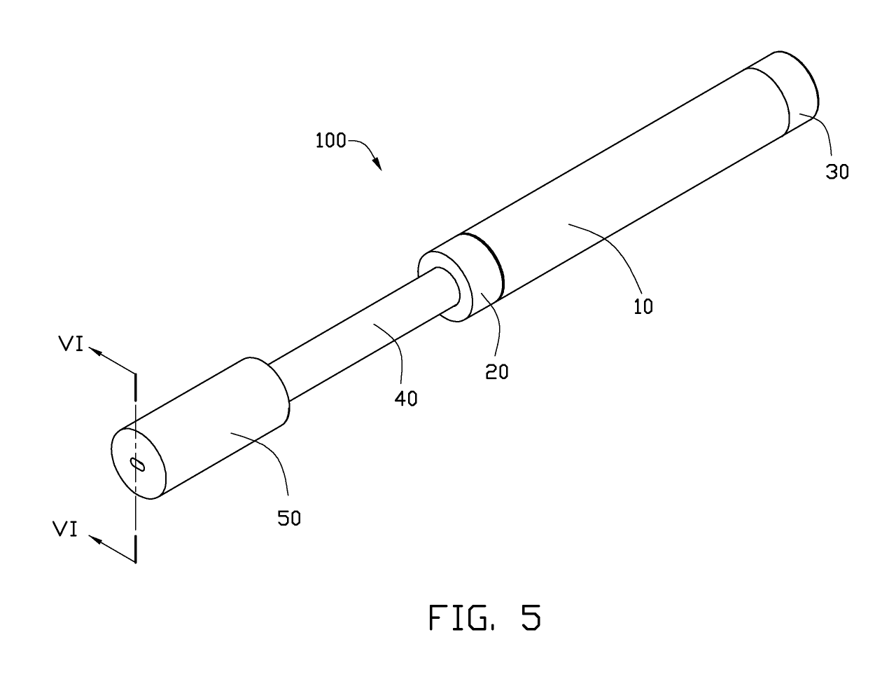

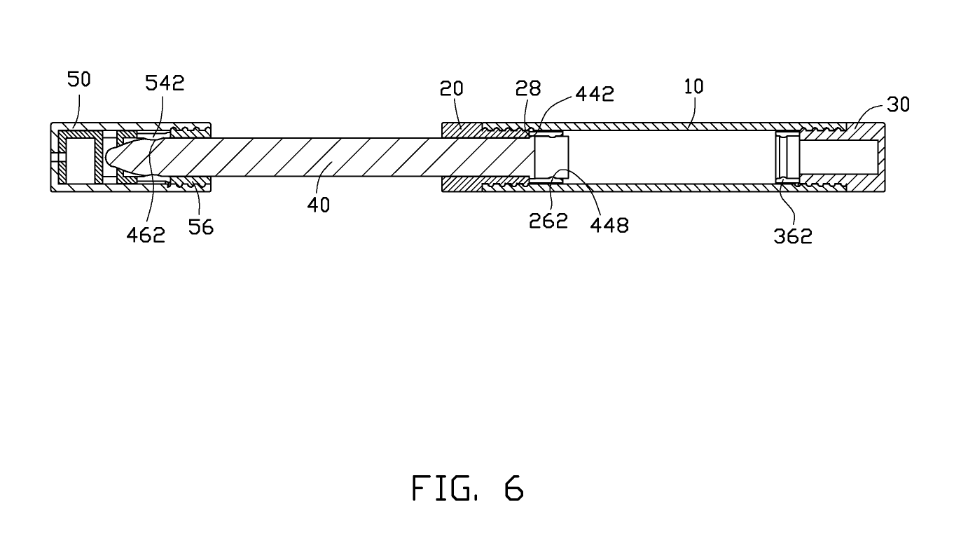

In use, referring to FIGS. 5 and 6, the user may pull the cap 50 of the stylus 100. The holding portion 54 pulls the core member 40 to cause the projection 362 to move out from the latching groove 448 until the projection 262 is received in the latching groove 448 to realize an extended state. The core member 40 can be stably kept in an extended state relative to the housing 10.

It is believed that the present embodiments and their advantages will be understood from the foregoing description, and it will be apparent that different changes may be made thereto without departing from the spirit and scope of the disclosure or sacrificing all of its material advantages, the examples hereinbefore described merely being preferred or exemplary embodiments of the disclosure.

What is claimed is:

1. A telescoping stylus comprising:
a housing;
a first stopper member attached to one end of the housing;
a second stopper member attached to another end of the housing;
a core member slidably received in the housing, the core member selectively engages with the first stopper member or the second member to be positioned in the housing.

2. The stylus holding mechanism of claim 1, wherein the first stopper member includes two opposite arms, and an arcuate projection protrudes from an inside of each arm, the core member includes two divisional latching wall, each latching wall defines a latching groove, the projections releasably engage in the latching groove.

3. The stylus holding mechanism of claim 2, wherein the first stopper member includes a head portion and a threaded portion connected to the arms, the threaded portion engages with an inner thread of the housing to allow the first stopper member to be fixed in the housing.

4. The stylus holding mechanism of claim 3, wherein the arms have a larger inner diameter than the thread portion, thereby a step being formed therebetween.

5. The stylus holding mechanism of claim 4, wherein the head portion has an outside diameter which is large enough to allow it to be abutted against one end of the housing.

6. The stylus holding mechanism of claim 1, wherein the core member includes a shank portion, a latching portion and a nib portion, the latching portion and the nib portion are formed at opposite ends of the core member.

7. The stylus holding mechanism of claim 6, wherein the latching portion defines a cutout along an axial direction of the core member to form the two latching walls.

8. The stylus holding mechanism of claim 6, further comprising a cap, wherein a ring slot is defined in the nib portion, a rib extends from an inner peripheral wall of the cap engaging in the ring slot.

9. A telescoping stylus comprising:
a housing;
a first stopper member fixed to one end of the housing;
a second stopper member fixed to another end of the housing;
a core member received in the housing, the core member engages with the first stopper member to position the core member in the housing in a first position;
wherein the core member is separate from the first stopper member and is slid to engage with the second stopper member to position the core member in the housing in a second position.

10. The stylus holding mechanism of claim 9, wherein the first stopper member includes a head portion and a threaded portion, the threaded portion engages with an inner thread of the housing to allow the first stopper member to be fixed in the housing.

11. The stylus holding mechanism of claim 10, wherein the first stopper member includes two opposite arms connected to the head portion and the threaded portion, and an arcuate projection protrudes from an inside of each arm.

12. The stylus holding mechanism of claim 11, wherein the core member includes a shank portion, a latching portion and a nib portion, the latching portion and the nib portion are formed at opposite ends of the core member.

13. The stylus holding mechanism of claim 12, wherein the latching portion defines a cutout along an axial direction of the core member to form two latching walls, each latching wall defines a latching groove, the projections releasably engage in the latching groove.
